(19) United States
(12) Patent Application Publication
(10) Pub. No.: US 2004/0078254 A1
(43) Pub. Date: Apr. 22, 2004

(54) Methods and systems for human resource budgeting and control

(76) Inventors: Andy Piechl, Ubstadt-Weiher (DE); Nicole Unser, Nussloch (DE)

Correspondence Address: Finnegan, Henderson, Farabow,, Garrett & Dunner, L.L.P., 1300 I Street, N.W., Washington, DC, 20005-3315, US

(21) Appl. No.: 10/601,170

(22) Filed: Jun. 20, 2003

Related U.S. Application Data
(60) Provisional application No. 60/389,925, filed on Jun. 20, 2002.

(51) Int. Cl. G06F 17/60

(52) U.S. Cl. 705/7

(57) ABSTRACT

The invention provides for a position budgeting and control system as well as for a method and a computer program for evaluating and controlling human resource budgets by retrieving human resource relevant data from a data base and evaluating a human resource budget for a given human resource object for a predefined period of time on the basis of said retrieved data, storing the result of said evaluation and monitoring said budget during said predefined period of time.

### RELATED APPLICATIONS

This application claims the benefit of provisional patent application No. 60/389,925, filed Jun. 20, 2002, which is hereby incorporated by reference.

### FIELD OF THE INVENTION

This invention relates to electronic data processing and, more particularly, to methods, computer program products, and systems for evaluating, controlling, and managing human resource budgets.

### BACKGROUND

Private companies, as well as the public sector, use automated systems in order to manage their human resources tasks, particularly payroll management. The human resource data administration often involves maintaining a data base with personnel data such as employee number, position, salary, possible benefits (gratuities, bonus payments, stock options etc.) salary history, pension information etc. Using this data, the system periodically creates payroll reports that may be provided to the employee as well as provided to an accounting system for use in paying employees.

During a budget cycle, employee salaries may change. For example, employees may receive a raise in salary, the cost of benefits may increase or decrease, or an employee may receive a bonus or be paid for overtime. In addition, the number of employees may change, that is, a new position may be created in a company or a department. In the budgeting process, it may happen that a company budgets for new employees at the beginning of the fiscal year, but when the new employee is subsequently hired, the money committed for the new hire may be no longer available. In conventional budgeting and accounting systems, this shortfall may not be recognized until the end of the year, causing the human resource department to be over budget and requiring a company to account for the shortfall by using money allocated to other departments.

It is therefore an object of the invention to provide for a system and a method which allow for better planning of human resources and thereby reduce or avoid exceeding available budgets for human resources.

### SUMMARY OF THE INVENTION

The present invention provides a position budgeting and control system which allows for human resource budget preparation for a defined period of time, such as, for example, a fiscal year, as well as control and management of the budget management during this given period of time. A system according to the present invention evaluates the costs for each position in a company or public authority and specifies the budget for each position for a defined period of time. This results in the reservation of a budget for a certain position in such a manner that the amount reserved in the budget cannot be spent for other purposes during said fiscal year.

According to the invention, the evaluation and the reservation of a budget may be done in a two step manner. In one embodiment, the first step comprises retrieving data base information on various types of human resource positions in a company or a public authority, respectively. In a second step, when evaluating an individual budget and payroll scenario for a certain employee occupying a given position, additional data base information on the employee is retrieved. The system according to the invention thus comprises a first data base containing position data and a second data base containing human resource data.

The data contained in both data bases may be retrieved and collected by a commitment engine. The commitment engine comprises an administrator module, an object collector module and a data collector module. The administrator module is the commitment engine's interface for communication with other hardware such as a first and second data base, input/output means, and the like, and controls the data flow through the object collector and data collector modules. The object collector modules retrieves requested objects and, in certain embodiments, also retrieves depending objects. The object collector may also retrieve data for the interval time periods after which new data collection is to be performed and encumbrances are to be calculated. The object collector module may also perform an object check on all the objects.

In certain embodiments, the commitment engine further comprises a creator module for creating budget control documents, an error handling module for handling errors and triggering workflows to overcome an error, and a transfer module for transferring budget data to exterior accountancy, said administrator module administering data flow to and from said creator, said error handling and said transfer modules. These modules are further described below.

The data collector module retrieves data base data for positions on the one hand and data base data for persons/employees (human resource objects) on the other hand. The data collector module also provides for an update of the salary data for all relevant objects. The data collector module further provides for payroll simulation or payroll calculation, respectively, as well as data collection in connection with personnel cost planning.

As stated above, the commitment engine may comprise a creator module, said creator module creating commitment documents. These documents serve as a basis for the reservation of funds in accounting, financial management and/or controlling. All payments, such as salary payments, may be calculated on the basis of these commitment documents.

As also stated above, the commitment engine may comprise a transfer module for transferring relevant payroll data to an accounting module, which, in some embodiments, may be separate from the commitment engine. The term accounting module performs the functions of accounting, financial management and controlling.

Further, the commitment engine may also comprise an error handling and clean up module for evaluating whether an object table contains an error and, if so, for triggering an error handling workflow.

Changes in the data base data may be automatically recognized by the commitment engine and the budget may be re-calculated and adapted. If the new budget extends beyond the former budget, an error workflow may be triggered.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings:

FIG. 1 shows one exemplary embodiment of a computer position budgeting and control system according to the invention.

FIG. 2 shows one exemplary embodiment of a more detailed view of the commitment engine of the computer system of FIG. 1.

### DESCRIPTION OF THE EMBODIMENTS

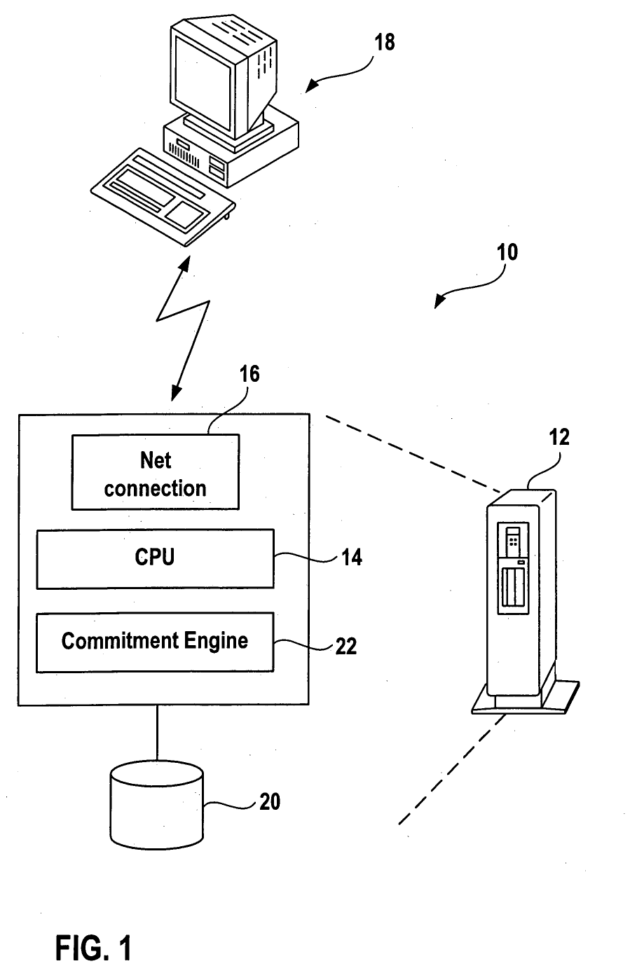

FIG. 1 shows a computer position budgeting and control system 10 according to the present invention. Computer system 10 comprises a server 12 with a central processing unit CPU 14, a net connection 16 for connection with at least one input/output means 18, and at least one data base 20 containing human resource data relating to human resource objects. The position budgeting and control system 10 of the invention further comprises a commitment engine 22.

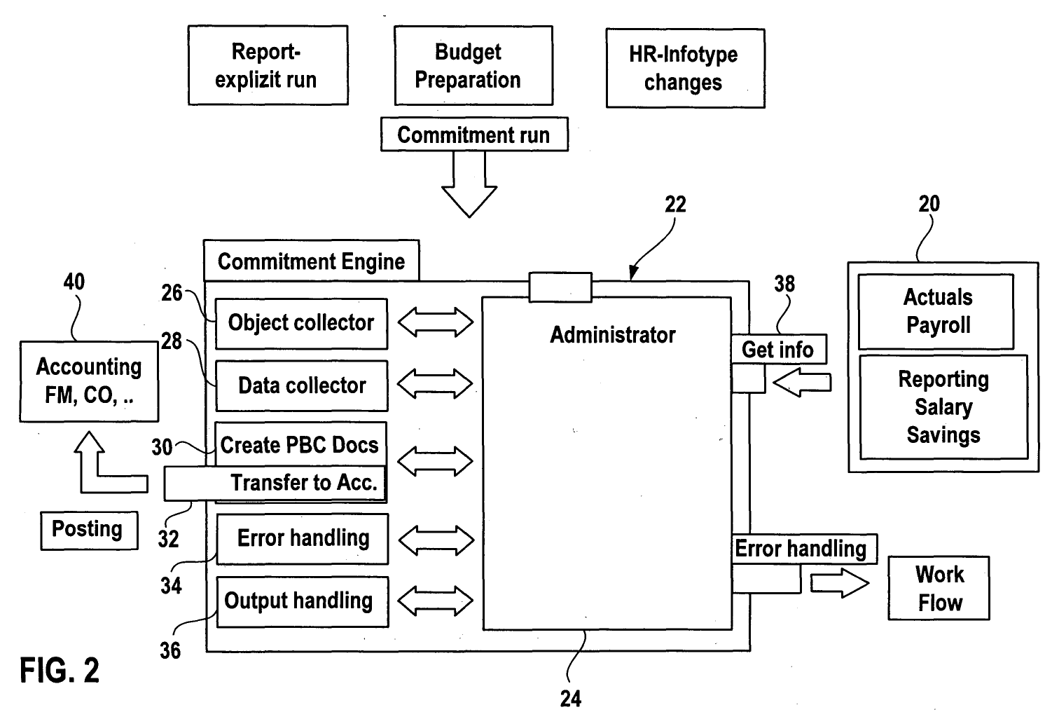

Referring now to FIG. 2, one exemplary embodiment of the commitment engine 22 is described in more detail. The commitment engine 22 comprises an administrator module 24, an object collector module 26, a data collector module 28, a creator module 30, a transfer module 32, an error handling module 34, and an output handling module 36. The administrator module 24 administers all data flow to and from said other commitment engine modules.

Particularly, the administrator module 24 retrieves various forms of data at 38, such as, for example, data relating to human resource objects from the human resource data base 20. This data relates to payroll data or salary savings data for a given human resource object.

The object collector module 26 retrieves, through the administrator module 24, requested human resource objects from data base 20. The object collector module 26 also retrieves data of objects depending on the retrieved requested object. Further data collected by the object collector module 26 are the intervals for a new data collection and encumbrances.

The data collector module 28 retrieves human resource data corresponding to the human resource object retrieved by the object collector module 26, including salary and benefit payment data. The data collector module 28 also provides for payroll simulation upon request and performs data collection with personal cost planning and rates the collected data with personal cost planning, and finally saves the results (through administrator module 24).

The creator module 30, based on the results delivered by data collector module 28, creates commitment documents (referred to herein as Position Budget Control (PBC) documents), which commitment documents form the basis for the reservation of funds in accounting 40. The transfer of the documents to accounting (or financial management (FM), controlling (CO), etc.) 40 is done through transfer module 32.

The error handling module 34 recognizes an error by evaluating data of a human resource object provided by the object collector and data collector modules 26, 28, which data may be provided as an object table. If an error is found by error handling module 34, the error handling module 34 triggers a workflow through administrator module 24 in order to launch a clean up process.

Operation of the computer system according to one embodiment of the present invention is as follows.

When planning the next fiscal period, such as the next fiscal year, certain positions and an according budget are approved. For the preparation of the budget, positions are defined and human resource objects, or persons, holding certain positions are defined. During budget preparation, changes to human resource data might occur. This budget plan specifies the approved positions for the upcoming fiscal year and how they are financed.

On the basis of this budget plan, a first commitment run is performed with the commitment engine. In this run, the commitment engine 22 reserves the approved budget for the approved positions for the time period chosen, such as the next fiscal year. It also creates the encumbrances for the positions and persons. This means that at least one embodiment of the present invention not only provides for a method to calculate funds needed for a given human resource planning, but also to fixedly reserve the corresponding budget by creating the according encumbrances. The budget and the encumbrances are automatically created and forwarded to accounting modules 40.

Certain embodiments of the present invention also provide for automatic update and adjustment by continuously repeating commitment runs of the commitment engine throughout the given time period. A commitment run may be performed after there are changes in the human resource data that are relevant to the salary. Such changes may be discovered by the data object collector and data collector modules 26, 28. Such changes are manually input into the human resource data base, but are usually not (or only after a delay) reported to management levels that are responsible for budget controlling. With certain embodiments of the present invention, such changes are discovered immediately by continuous screening and comparing of data. After discovering such a relevant change, the commitment engine automatically launches a commitment run, calculating any differences occurring to the budget reservation due to the human resource data change. Certain embodiments of the present invention allow data, which could hitherto only be used by certain persons because it was classified sensitive data, to be used without time delay in a highly efficient automated manner. Data relating to these changes can be immediately provided to accounting modules whereby the changes can be analyzed and considered.

During a certain period of time, the commitment engine may also perform commitment runs after each payroll creation and reduce the encumbrance reservations accordingly.

In certain embodiments, the calculation and reservation of funds is done in three steps, namely a reservation step, a pre-commitment step and a commitment step. In the reservation step, calculation is performed on the basis of the budget preparation result only for a position. The result of this calculation is adapted after a budget preparation run for this position. In the pre-commitment step, calculation is performed only for vacant and for occupied positions, under consideration of the according data sources for vacant positions and occupied positions, and a simulation for the fiscal year's costs is performed. The result of this pre-commitment step might affect the result of the first reservation step and adaptation might become necessary. In the commitment step, the system calculates needed funds in connection with persons only. Calculation is performed on the basis of human resource data sets and a payroll simulation is performed. Again, the result of this step might affect the result of a prior pre-commitment step and adaptation might become necessary. The results of the two latter steps may need to be adapted when changes to the according data sets for positions and/or human resource objects occur.

In at least one embodiment, a pre-commitment is calculated first and then a commitment is calculated, the latter forming the basis for a reservation of encumbrances in accounting. However, the reserved funds are continuously compared to what actual developed, that is to the effected salary payments and to changes in the data sets, such as the occupation of a vacant position or raise for a certain human resource object. If a comparison shows that the budget is not in line with reality (or vice versa), the evaluation may need to be adapted. If this leads to an error, such as, for example, a budget overflow, an error workflow may be triggered via error handling module 34. Due to the continuous comparison and payroll simulation, changes which would lead to overdrawing the budget are discovered well in advance and can be remedied.

An error workflow as mentioned above may be indicated by, for example, outputting a detailed message through output handling module 36 and administrator module 24 to an authorized person, such as an executive personal manager. In this message, a detailed reasoning for error occurrence together with a proposed workflow for remedy may be given. The error handling module may also determine the responsible department for the error that occurred, such as the human resource department, the payroll department, the accounting department, or the administrator of the commitment engine. It may also determine which departments need to assist in correcting or remedying the cause for the error. According to the findings of the error handling module, a workflow may be generated that involves one or more of the departments mentioned above.

When an error occurs, the error handling module may set a corresponding set of data to an error status, such as “E”. As soon as the cause of the error has been removed or, for example, the appropriate managing entity has given clearance or approval, the error handling module may set the corresponding set of data to an approved status, such as “A”, and adaptation of the funds reservation status can be initialized.

What is claimed is:

1. A position budgeting and control system for evaluating and controlling human resource budgets, comprising:
a central processing unit;
input/output means;
at least one data base containing human resource data relating to human resource objects; and
a commitment engine,
said commitment engine retrieving human resource relevant data from said at least one data base and evaluating a human resource budget for a given human resource object for a predefined period of time on the basis of said retrieved data, said commitment engine further storing the result of said evaluation and monitoring said budget during said predefined period of time.

2. The system according to claim 1, wherein said commitment engine comprises an administrator module, an object collector module and a data collector module, said administrator module being connected to said object collector module and said data collector module, said administrator module administering data flow to and from said object and data collector modules, said object collector module retrieving objects from said at least one data base means and said data collector means collecting data from said at least one data base and writing updated human resource data to said at least one data base.

3. The system according to claim 2, said commitment engine further comprising a creator module for creating budget control documents, an error handling module for handling errors and triggering workflows to overcome an error, and a transfer module for transferring budget data to exterior accountancy, said administrator module administering data flow to and from said creator, said error handling and said transfer modules.

4. The system according to claim 2, wherein said human resource data consists of position data and individual employee data.

5. The system according to claim 2, wherein said commitment engine calculates individual employee salary on the basis of said retrieved data.

6. The system according to claim 5, wherein said commitment engine calculates said individual employee salary for said predefined period of time as a budget and monitors said budget during said period of time.

7. The system according to claim 6, wherein said commitment engine combines several of said individual employee salary budgets into a department or cost center budget.

8. The system according to claim 7, wherein said commitment engine monitors said department or cost center budget during said period of time.

9. The system according to claim 6, wherein said monitoring involves a comparison of said calculated budget with actually effected salary payments.

10. The system according to claim 8, wherein said monitoring involves a comparison of said calculated budget with actually effected salary payments.

11. The system according to claim 4, wherein said commitment engine calculates position cost simulations for employee positions on the basis of said position data for said predefined period of time, the sum of said position cost simulations being the potential position budget for an employer entity or sub-entity for said predefined period of time.

12. The system according to claim 4, wherein said commitment engine calculates employee cost simulations for an existing employee on the basis of said individual employee data for said predefined period of time, the sum of said employee cost simulations being the actual employee budget for an employer entity or sub-entity for said predefined period of time.

13. The system according to claim 11, wherein said commitment engine provides an indication for a hiring decision regarding hiring of new personnel on the basis of the difference between said potential position budget and said actual employee budget.

14. The system according to claim 12, wherein said commitment engine provides an indication for a hiring decision regarding hiring of new personnel on the basis of the difference between said potential position budget and said actual employee budget.

15. The system according to claim 4, wherein said commitment engine automatically recognizes changes to said human resource data that are relevant to said budget and re-evaluates said budget.

16. A method for evaluating and controlling human resource budgets, comprising:
retrieving human resource relevant data and evaluating a human resource budget for a given human resource object for a predefined period of time on the basis of said retrieved data, and
storing and monitoring said budget during said predefined period of time.

17. A method according to claim 16, further comprising:
reserving funds according to said evaluated human resource data.

18. A method according to claim 17, further comprising: continuously adapting said reserved funds by subtracting effected salary payments.

19. A method according to claim 16, further comprising:
on the basis of a budget preparation, performing a reservation step for a human resource position only, then performing a pre-commitment step for occupied and vacant human resource positions only on the basis of retrieved specific position data, and then performing a commitment step for human resource objects only on the basis of retrieved specific object data, and subsequent adaptation of the results of the respective prior steps.

20. A method according to claim 19, further comprising:
reserving funds for said predefined period of time on the basis of said commitment step.

21. A method according to claim 19, further comprising:
continuous adaptation of the results of said pre-commitment and commitment steps based on changes to said human resource position data.

22. A method according to claim 19, further comprising:
continuous adaptation of the results of said pre-commitment and commitment steps based on changes to said human resource object data.

23. A computer program product for evaluating and controlling human resource budgets embodied by a computer readable medium, the computer program product comprising instructions to cause a processor of a computer to execute the following steps:
retrieving human resource relevant data and evaluating a human resource budget for a given human resource object for a predefined period of time on the basis of said retrieved data, and
storing and monitoring said budget during said predefined period of time.

24. A computer program product according to claim 23, further comprising instructions for:
reserving funds according to said evaluated human resource data.

25. A computer program product according to claim 24, further comprising instructions for:
continuously adapting said reserved funds by subtracting effected salary payments.

26. A computer program product according to claim 23, further comprising instructions for:
on the basis of a budget preparation, performing a reservation step for a human resource position only, then performing a pre-commitment step for occupied and vacant human resource positions only on the basis of retrieved specific position data, and then performing a commitment step for human resource objects only on the basis of retrieved specific object data, and subsequent adaptation of the results of the respective prior steps.

27. A computer program product according to claim 26, further comprising instructions for:
reserving funds for said predefined period of time on the basis of said commitment step.

28. A computer program product according to claim 26, further comprising instructions for:
continuous adaptation of the results of said pre-commitment and commitment steps based on changes to said human resource position data.

29. A computer program product according to claim 26, further comprising instructions for:
continuously adapting the results of said pre-commitment and commitment steps based on changes to said human resource object data.
